(19) United States
(12) Patent Application Publication
(10) Pub. No.: US 2026/0342790 A1
(43) Pub. Date: Oct. 29, 2026

(54) IDENTITY VERIFIED USER CONNECTION TO FACILITATE EXCHANGE OF INFORMATION

(71) Applicant: Courtyard AI Inc., Toronto (CA)

(72) Inventors: Samuel PAJOT-PHIPPS, Calgary (CA); Jason COLBURNE, Halifax (CA); Peter CARRESCIA, Toronto (CA)

(21) Appl. No.: 19/655,840

(22) Filed: Apr. 23, 2026

Related U.S. Application Data
(60) Provisional application No. 63/793,341, filed on Apr. 23, 2025.

(51) Int. Cl. H04L 9/40; G06F 21/60; G06Q 50/26

(52) U.S. Cl. CPC H04L 63/0861; G06F 21/602; H04L 63/126; G06Q 50/26

(57) ABSTRACT

A computer-implemented platform enables previously unconnected users to establish an identity-verified connection and exchange identity-bound information. A server verifies users through a process that can include email verification, biometric verification, validation of a government-issued identification document, and duplicate-user checking. After a verified first user requests an invite code, the server generates and stores the invite code in association with a distinct user identifier of the first user. When a second user device provides the invite code, the server identifies the first user, determines whether a second user is verified, and, upon confirmation, causes the second user device to present an option to connect. Responsive to selection of the option, the server establishes a secure encrypted messaging channel through which the users exchange authenticated personal information items and free-format messages.

### RELATED APPLICATION DATA

This application claims the benefit under 35 U.S.C. § 119(e) of U.S. Provisional Application No. 63/793,341, filed April 23, 2025, the entire contents of which are incorporated herein by reference.

### BACKGROUND

In the age of ubiquitous online connectivity, users often connect with other users through digital channels via texting, messaging, and email, as well as through social media platforms such as Facebook™, Whatsapp™, and Reddit™, to name just a few. These platforms / technologies all allow for some level of anonymity. Bad actors have taken advantage of this, and this anonymity can be leveraged for nefarious purposes such as fraud and theft.

The problems caused by anonymity on digital channels has become critical. With the advent and rapid adoption of real time (or near real time) payment systems, consumers have increasingly become victims of authorized push payment (APP) fraud. APP Fraud is a type of fraud where a victim willingly transfers funds through a payment system to a bad actor, often through the use of social engineering and impersonation.

Accordingly, there is a need for methods and systems that can address at least some of the shortcomings noted above.

### SUMMARY

According to example aspects, methods, systems, devices, and processor-readable media are as set out in the claims below to enable identity verified user connections to facilitate exchange of information bound to the verified identities.

The disclosed technology provides a computer‑implemented method and system for securely connecting previously unconnected users and enabling the exchange of identity‑bound information through a secure messaging channel. A server verifies users through an automated identity verification process that includes biometric authentication, validation against government‑issued identification, and duplicate user detection. Upon successful verification, users are associated with unique user identifiers and corresponding verified user records.

A first verified user requests and receives a unique, optionally single‑use invite code generated by the server and bound to the first user’s verified identity. The invite code may be associated with context data, such as a predefined purpose, user role, and descriptive information. When the invite code is received from a second user device, the server identifies the first user based on the code, validates the code (including expiration conditions), and determines whether the second user is also a verified, non‑duplicate user.

Upon confirming the verification status of both users, the server causes the second user device to present a selectable option to connect with the first user, together with any associated context data. When the option is selected, the server establishes a secure, encrypted messaging channel between the users’ devices using cryptographic keys bound to their verified identities. Through the secure messaging channel, the users may exchange free‑format messages and selected personal user data items that are authenticated and cryptographically bound to their verified identities.

The exchanged personal user data may include, by way of example, verified profile pictures, payment handles, social media identifiers, endorsements, and other authenticated profile information. The personal data exchanged between users may be selectively shared and presented in a defined format on the respective user devices. The system therefore enables trusted, privacy‑preserving, and context‑aware connections between verified users, while mitigating fraud, impersonation, and duplicate account creation.

According to a first example aspect, a computer-implemented method is disclosed for enabling exchange of identity-bound information between previously unconnected users. The method includes: receiving, by a server from a first user device associated with a first user, a request to generate an invite code for the first user, the first user having previously completed a verification process; generating, by the server, the invite code for the first user; storing, by the server, the invite code in association with a distinct user identifier of the first user; receiving, by the server from a second user device associated with a second user, the invite code; identifying, by the server, the distinct user identifier of the first user based on the invite code; determining, by the server, whether the second user has completed the verification process; responsive to determining that the second user has completed the verification process, causing the second user device to present a selectable option to connect the second user with the first user; and responsive to receiving an indication that the selectable option has been selected, causing a secure messaging channel to be established between the first user device and the second user device.

In some examples, the verification process for each of the first user and the second user comprises: performing automated identity verification based on biometric data obtained from the user and a representation of a government-issued identification document provided by the user; performing duplicate-user checking by comparing the biometric data obtained from the user against stored biometric data for users who have previously undergone the verification process; and responsive to successful automated identity verification and successful duplicate-user checking, updating user data associated with the distinct user identifier of the user to indicate that the user is a verified user.

According to a second example aspect, the computer‑implemented method for securely enabling exchange of identity‑bound information between previously unconnected users comprises: verifying, by one or more processors of a server, an identity of a first user by performing biometric verification using biometric data captured by a first user device and by confirming the first user is not a duplicate user based on comparison of the biometric data against stored biometric data for previously verified users; storing, by the server, a verified user record associated with a unique user account identifier for the first user; generating, by the server, a single‑use invite code bound to the unique user account identifier of the first user, the invite code being associated with stored context data and an expiration condition; receiving, by the server and from a second user device, the invite code; validating, by the server, that the invite code is unexpired and bound to the verified user record of the first user; determining, by the server, that a second user associated with the second user device is a verified non‑duplicate user based on biometric verification; responsive to validating the invite code and determining that the second user is verified, establishing, by the server, a secure encrypted messaging channel between the first user device and the second user device using cryptographic keys associated with the verified user records; and transmitting, via the secure encrypted messaging channel, one or more authenticated personal information items that are cryptographically bound to the verified identity of at least one of the first user or the second user.

According to a further example aspect, a system is disclosed that comprises: one or more processors; and one or more memories storing machine-executable instructions that, when executed by the one or more processors, cause the system to perform one or more of the preceding methods.

According to a further example aspect is a computer readable non-transitory medium that stores machine-executable instructions that, when executed by one or more processors, cause the one or more processors to perform one or more of the preceding methods.

### BRIEF DESCRIPTION OF THE DRAWINGS

Reference will now be made, by way of example, to the accompanying drawings which show example embodiments of the present application, and in which:

FIG. 1 is an illustration of a system that enables identity verified user connections to facilitate exchange of information, according to example embodiments.

FIGS. 2A to 2G show examples of interactive user interface (UI) screens displayed by a user device of the system of FIG. 1 during user onboarding and invite creation processes, according to example embodiments.

FIG. 3 is a flow diagram illustrating a user onboarding process performed by components of the system of FIG. 1 according to example embodiments.

FIG. 4 is a flow diagram illustrating an invite code creation process performed by components of the system of FIG. 1 according to example embodiments.

FIG. 5 is a flow diagram illustrating an invite code acceptance process performed by components of the system of FIG. 1 according to example embodiments.

FIGS. 6A-6C show examples of interactive UI screens displayed by a user device of the system of FIG. 1 during the invite code acceptance process, according to example embodiments.

FIGS. 7A-7B show examples of interactive UI screens displayed by a user device of the system of FIG. 1 when users are connected.

FIG. 8 shows an example of home UI screen displayed by a user device of the system of FIG. 1.

Similar reference numerals may have been used in different FIGs to denote similar components.

### DESCRIPTION OF EXAMPLE EMBODIMENTS

According to example embodiments, systems, devices and methods are described that enable users to verify their identities digitally, and connect with other verified users, all digitally, providing users a way to establish trust with others and reduce risks associated with impersonators that may attempt to hide behind anonymous accounts. In example embodiments the disclosed solution is ubiquitous and works across all digital communication channels (Facebook, Reddit, email, messaging etc.) that a device user may use.

Over time, as users continue to use identity-verified connections to successfully transact with other users, a portable, reusable identity-verified reputation is created which can also be used as an important marker for a user’s trustworthiness. Endorsements which cannot be gamed, that can only be issued by other identity-verified users, provide a powerful input to establishing trust.

According to example embodiments, the disclosed system, devices and methods support the following features, which are each described in greater detail below:

All users are identity verified. ID verification technologies are applied such that each user’s identity is confirmed and bound to biometric data.

Unique invite codes used to connect users. Based on some pending event (e.g. a transaction - a purchase or sale, a rental, a trade), a unique code (e.g. an “invite code”) is generated and privately or publicly shared by one party through a digital channel like Facebook, Reddit, email, chat, etc. By way of example, the invite code could be an alphanumeric sequence of characters that can be shared discreetly, or embedded in an electronic link or Quick Response QR code. The counterparty interested in the transaction, once also identity-verified, and upon verifying the veracity of the invite code, can use the code to establish an identity-verified connection between the two parties in advance of the transaction.

Exchange of identity-bound information. Once two identity-verified users have connected through an invite code, they have the ability, either programmatically or through ad-hoc chat, to exchange information that is now bound to their identities. The selection of what data to share is controlled by the user, ensuring the privacy preserving focus of the platform. Information shared can include payment handles for services like Venmo, Zelle, Cash App, crypto wallets, Visa/Mastercard/AMEX Direct, Interac. Ensuring the payment handle belongs to the legal identity of the person you believe it does, eliminates anonymity- driven APP fraud. Other information that can be selected and shared can be social media handles including Reddit usernames, Whatsapp numbers, Facebook names, etc.

Portable and reusable identity-verified reputation. As identity-verified users connect, establishing trust and completing transactions safely, they generate reputation. This reputation can only be built through unique, identity-verified users, and so is difficult to fake or game. It is also portable – unlike for example star ratings on Facebook or eBay, which are locked into those platforms, this reputation can be used across all platforms and cannot be easily gamed.

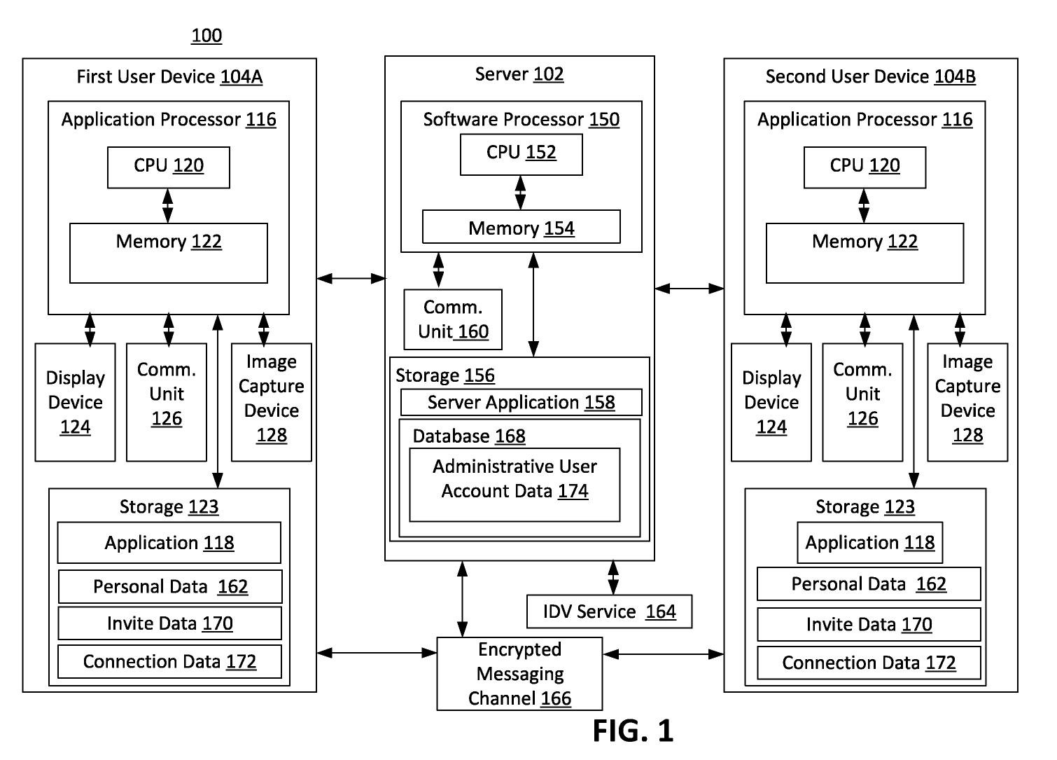

In this regard, FIG. 1 is an illustration of a system 100 that enables identity verified user connections to facilitate exchange of information (referred to herein as “verified user connection system 100” or “system 100”). The system 100 can include a server 102, multiple user devices 104A, 104B (shown in the FIG. 1 as first user device 104A and second user device 104B in FIG. 1, and generically referred to in this disclosure as user device 104 unless reference to a specific device is required). Each user device 104 can, for example be a mobile device such as a smartphone, tablet computer, laptop computer, or other communications enabled computer device, and can include an application processor 116 for executing one or more applications including an application 118 for validating parties and facilitating a transaction as discussed in greater detail below. The application processor 116 can include an integrated circuit with a central processing unit (CPU) 120 connected to memory 122. The application 118 can include, for example, resources and code for effectuating the functionality described herein. The application 118 can be stored in user device's persistent storage 123 (e.g., hard drive, solid-state drive, flash drive, or other non-volatile memory). In the instance that the user of user device 104 launches the application 318, the application's resources and code can be loaded into the memory 122 (e.g., random access memory (RAM)) to allow the CPU 120 to quickly access the application 118.

User device 104 can further include a display device 124 (e.g., a touchscreen). A user can interact with the application 118 using the display device 124. For example, the user can use a touchscreen to make one or more selections for the application 118. The user can also receive one or more messages from the application 118 via the display device 124. User device 104 can also include a communication unit 126 for interfacing with external computing devices. For example, the communication unit 126 can include software and circuitry for communicating using various technologies (e.g., Bluetooth, cellular, near field communication (NFC), Wi-Fi, and other communication technologies). The communication unit 126 can be used, for example, to communicate with the server 102. The user device 104 can further include an image capturing device 128. The image capturing device 128 can, for example, be used to capture a self-portrait photograph of the user of the user device 104.

The server 102 can include a combination of hardware and server application 158 that collectively provide a platform for verifying users of the first user device 104 and second user device 140 and facilitating a transaction between such users. For example, server 102 can be configured to function as a web-based user verification and transaction support platform that interacts with user devices that are respectively provisioned with application 118. The server 102 can include one or more computer systems, each of which may for example include one or more software processors 150 including an integrated circuit with a CPU connected to memory 154. The server application 158 can include, for example, resources and code for effectuating the functionality described herein. The server application 158 (including resources and code) can be stored in a persistent storage 156 (e.g., hard drive, solid-state drive, flash drive, or other non-volatile memory), with the resources and code of software 158 loaded into the memory 154 (e.g., random access memory (RAM)) to allow the CPU 152 to perform its intended functionality. Server 102 can also include a communication unit 160 for interfacing with external computing devices. For example, the communication unit 160 can include software and circuitry for communicating using various technologies (e.g., Ethernet, Bluetooth, cellular, near field communication (NFC), Wi-Fi, and other communication technologies). The communication unit 160 can be used, for example, to communicate with the user devices 104.

In an example implementation server 102 maintains a database 168 that stores respective administrative user account data 174 for users of the system 100. For example, database 168 could be stored in persistent storage 156 of the server 102 or in one or more persistent storage devices that are accessible to server 102. The administrative user account data 174 that is stored for individual users of the system 100 can include the unique user account ID for a user and associated user data for that user. “Associated” as used herein in connection with data means that a first piece of data (e.g., a unique user account ID) can be used to retrieve other data that is associated with it. In the case of the unique user account ID, its associated data can include, among other things: a user account status identifier; user’s verified email address(es); user password; current and historic invite data; pre-connection sharable user data, and current and historic connection data. In some examples, a copy of the administrative user account data 174 for a user can also be stored in the storage 123 of the user device 104 of that user.

In one example, the pre-connection sharable user data stored by server 102 in connection with a user can include user information that is intended to be publicly displayed to provide a further user with sufficient information to confirm that they should be accepting an invite code. For example, the pre-connection sharable user data for a user can include a blurred-beyond-recognition image of the user (e.g., a blurred version of the user’s verified profile picture that is described below) and part of the user’s name for example a first name).

In example implementations, the user device 104 must be provisioned with application 118. For example, a user associated with a user device 104 can cause the user device 104 to download an application package for application 118 and install application 118 on the user device 104. For example, a user could interact with user device 104 to cause the application package to be downloaded from an app store such as provided by Google™ or Apple™ for installation on user device 104. In at least some examples, a unique device ID is obtained by the server 102 for each application download to enable the server 102 to uniquely track future interactions with the downloading user device 104. The unique device ID can be stored in server database 168, and also stored at the user device 104.

### User Onboarding

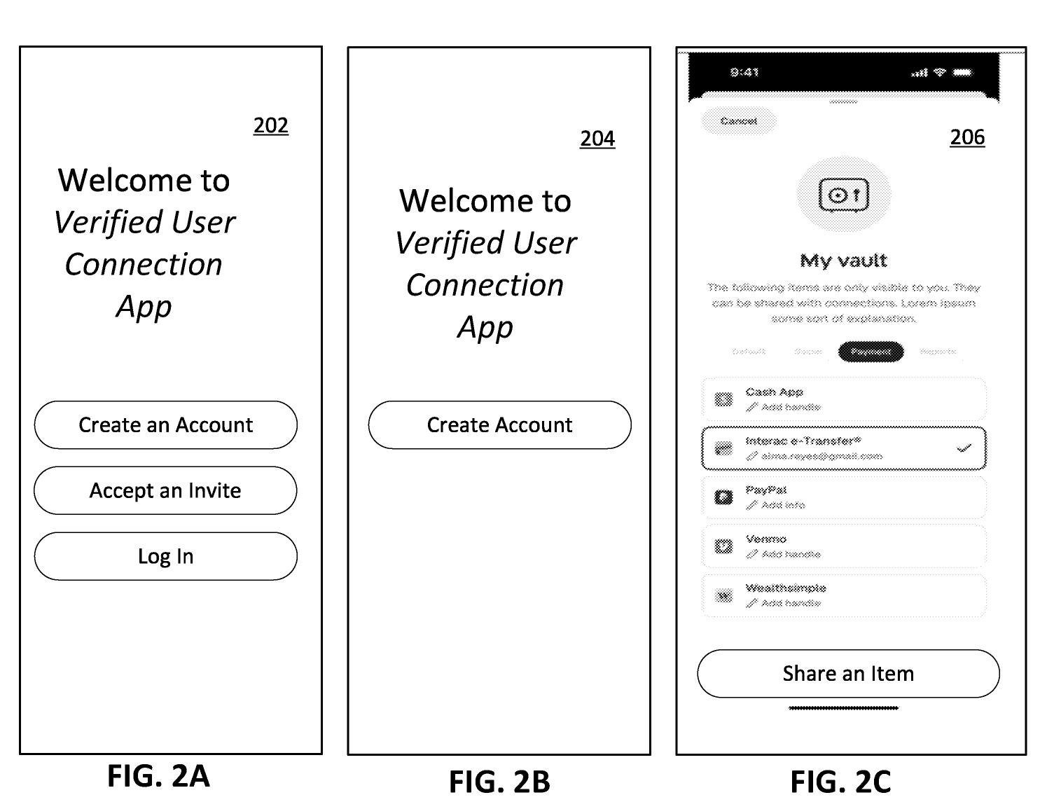

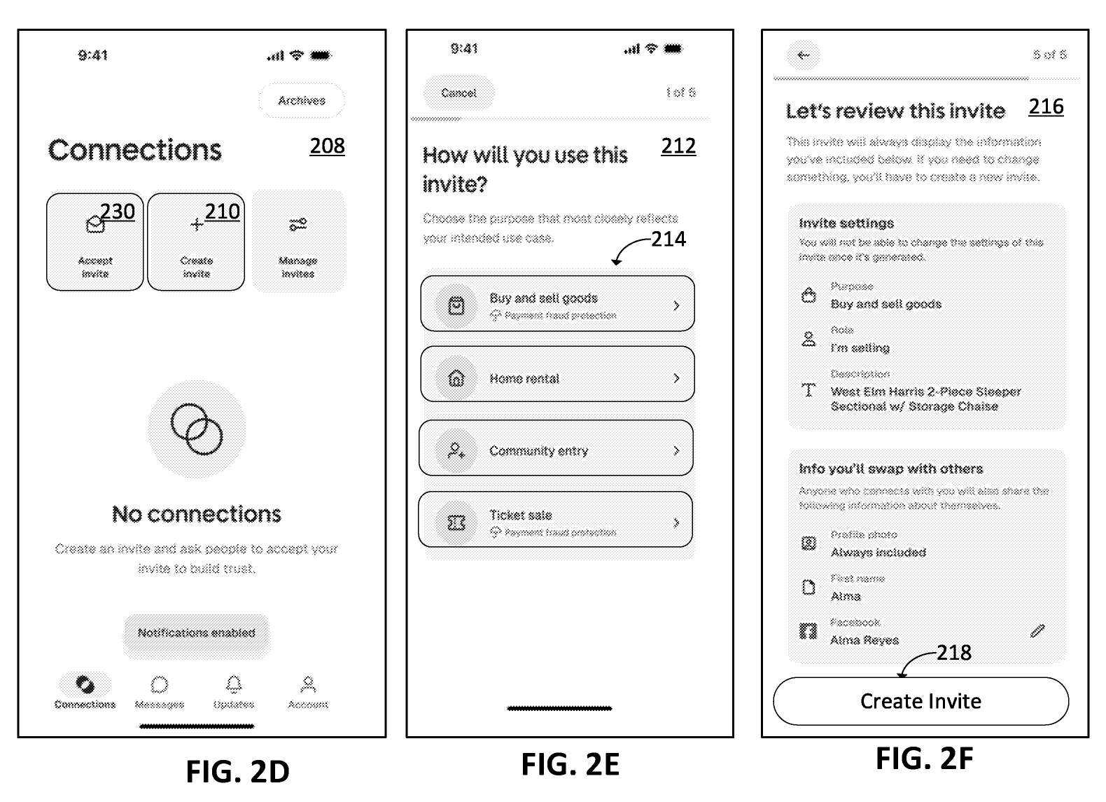

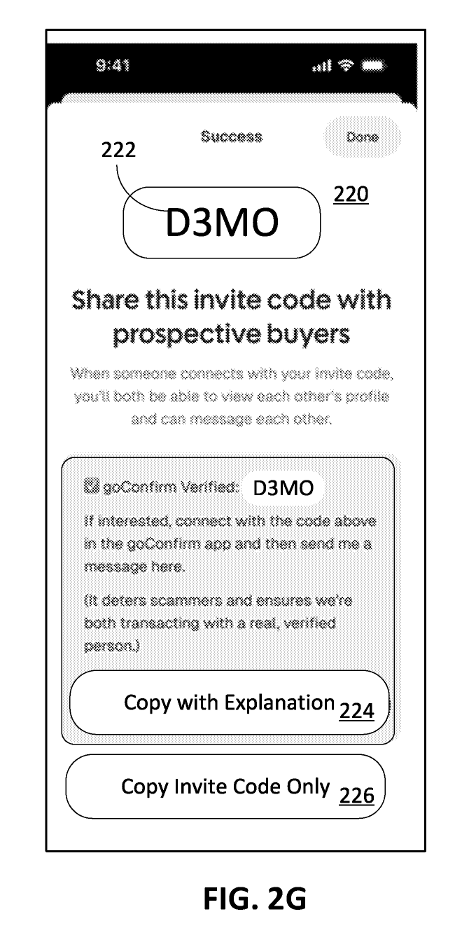

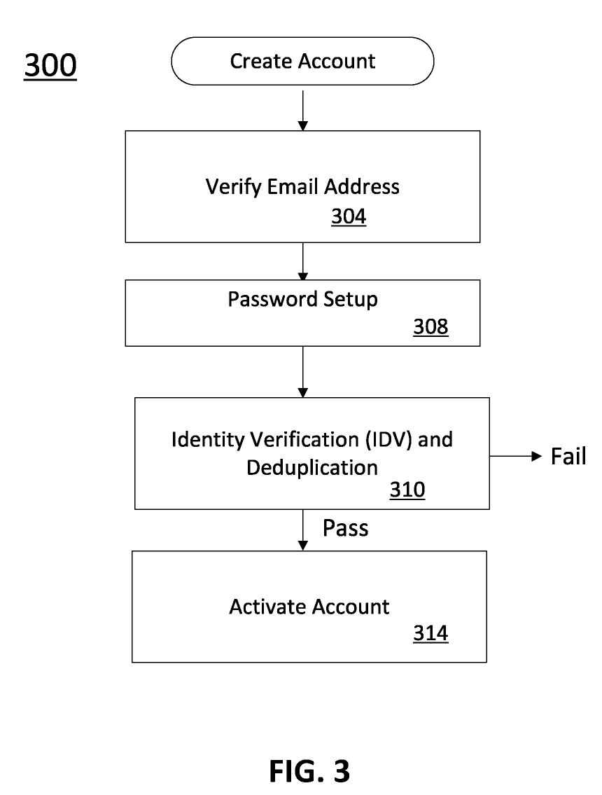

FIG. 3 shows a flow diagram illustrating a user onboarding process 300, according to example embodiments. A series of mobile user interface (MUI) screens, some of which are exemplified in FIGS. 2A to FIG. 2C, can be presented by the user device 104 throughout onboarding process 300 to prompt the device user to provide input as required to complete the onboarding operations described below.

FIG. 2A shows a MUI screen 202 that is generated when the application 118 is first launched after installation. After application 118 is installed, a user must go through an onboarding process during which they must verify their identity and register a personal account with the server 102 to become a verified account holder who can use the system 100. For example, in FIG. 2A, the onboarding process can be initiated by user selection of a “Create an Account” UI control of MUI screen 202. As will be explained in greater detail below, user selection of a “Accept an Invite” UI control can also be used to start the onboarding process.

In an example embodiment, once an onboarding process 300 begins, a user email address verification operation 304 is performed. The email address verification operation 304 can include typical email verification steps, for example: Application 118 causes user device 104 to (i) present a form where the user enters their email address; (ii) check the email format to ensure its plausibly valid (e.g., contains "@" and a domain); (iii) send the entered email address to the server 102. The server 102 (i) creates a unique verification code or a unique link associated with the email address; (ii) uses an email service to send the verification code or link to the user's provided email address as part of an email (e.g., see display screen 204 of FIG. 2B); (iii) waits for the user to click the link (e.g., “Create Account” link in screen 204) (if using a link) or enter the code (if using a code); (iv) verifies that the code or link used by the user is valid and hasn't expired; and (v) if the email verification is successful, updates the user's email verification status in a server database (for example database 168), indicating the email address is verified. Once verified, the server 102 sends an authorization to the user device 104 that allows the user to continue to with the onboarding functionality enabled by application 118.

Although the onboarding process can initially rely on the unique device ID, in at least some examples, server 102 assigns a unique user account ID for a user during the onboarding process and starts storing administrative user account data 174 that is specific to that unique user account ID and that is required for the server 102 to perform its functions. In some examples, the unique user account ID for a user can be assigned as part of the email verification process. All other data that is connected to or related to a user can be stored in association with the unique user account ID, meaning that the unique user account ID can be used to retrieve to the other data.

Upon the completion of email verification, the user onboarding process 300 continues to a password setup operation 308 during which the user is prompted to enter a password that can be added to the administrative user account data 174 for that user.

Onboarding process 300 can then proceed to a user identity verification (IDV) and deduplication operation 310, which is a multi-step operation to confirm a user's identity and also confirm that the user has not previously obtained a user account under a different name or the same name. IDV and deduplication operation 310 can include document verification, biometric checks, and data verification against trusted databases. In an example implementation, server 102 interacts with user device 104 and calls on an IDV service 164 to perform IDV and deduplication operation 310. In some examples, IDV service 164 can be provided by a third party and accessed through an application programming interface (API) provided by that third party. By way of example, Persona Identities, Inc. operates an IDV platform known as Persona™ that can be used to provide IDV service 164. In some alternative examples, some or all of the functionality of IDV service 164 can be integrated into server 102 instead of relying on a third-party service. In one example, IDV and deduplication operation 310 can include at least some of the following steps:
1. Document Verification: (i) Government ID Capture: IDV service 164 interacts with user device 104 to cause user device 104 to prompt its user to use image capture device 128 to submit a photograph of a government-issued ID (like a passport, driver's license, or national ID, for example). In some examples, the Government ID can be a digital document stored on the user device 104 (e.g., mobile Drivers License (mDL)), in which case the government ID capture can be performed by a device to server connection where the digitally signed Government ID is provided to the server after the user has biometrically unlocked access to the digital signed Government ID. (ii) Data Extraction: IDV service 164 uses systems to extract key data points from the ID, such as name, date of birth, and ID number. (iii) Document Authentication: IDV service 164 uses various techniques to verify the authenticity of the ID, such as checking for fakes, tampering, or expired documents. In some examples, multiple pieces of Government ID (or other trusted source ID documents) may be required to be submitted for user verification.
2. Biometric Verification: (i) Liveness Checks: IDV service 164 interacts with one or both of server 102 and user device 104 to cause user device 104 to prompts a user to use image capture device 128 to take a selfie or video to ensure that the user is a real person and not a simulated image. In some examples, IDV service 164 system may employ liveness detection techniques to verify that the user is not displaying a static image or video. (ii) Facial Recognition: Biometric data from the user submitted selfie and/or video is compared against the photo on the submitted government ID to verify the identity of the user.
3. Data Verification: (1) Database Cross-referencing: IDV service 164 compares the extracted data from the ID and the user's submitted information against trusted databases, including government records, credit bureaus, and watchlists. (2) Risk Scoring: IDV service 164 uses automated systems to analyze the cross-referencing results and assign a risk score based on potential discrepancies or red flags.
4. Deduplication: In example implementations, IDV service 164 is configured to maintain a historic database of biometric data obtained from previously submitted selfies and/or videos for users who have previously gone through onboarding process 300 for system 100. The newly obtained biometric information is compared against the historic database to ensure that the biometric data is unique and the submitting user is not trying to obtain a new account (e.g., a “burner account”) with system 100 under a different identity.
5. Decision Making: IDV service 164 can, based on the verification checks, risk scores and duplication checking described above, automatically confirm or reject the user’s asserted identity, and provide the decision (e.g., user identity “verified” or user identity “not verified”) to the server 102 and/or user device 104.

In the event the user identity is not successfully verified in step 310, the onboarding process 300 can be terminated. In some examples, prior to terminating the onboarding process 300, the user may be prompted to repeat to repeat the process with different ID and/or a new selfie image capture.

If, and only if, a user passes IDV and duplicate checking operation 310 the user is deemed to be a unique and verified user and server 102 activates a system account (operation 314) for that user. In one example, activation of a system account for the user includes updating, by server 102, the account status data for the user in the administrative user account data 174 to indicate a status of “verified and active”. Activating the system account for a user can also include obtaining the pre-connection sharable data of the user (e.g., a blurred version of the user’s verified profile picture and a display name (e.g., first name) for the user, and storing that data as part of the administrative user account data 174 for the user. This pre-connection sharable data is intended to allow some user data to be shared in advance of a connection, but still maintain the pre-connection privacy of the user.

As part of the account activation operation 314 for a user, user specific encrypted personal data 162 (e.g., a user “vault”) is also created for that user which stores a set of encrypted digital user information items unique to that user’s account ID for supporting future user identity verification and information exchange activities. In one example, the system 100 is configured as a decentralized system and the user personal data 162 is stored in the persistent storage 162 of user device 104, or at a remote storage platform linked to user device 104 (e.g., Apple™ cloud storage or Google™ cloud storage). In other examples the system 100 can be configured as a centralized system and the encrypted user personal data 162 for a user can be stored in a storage 156 of server 102. In some examples, a hybrid centralized-decentralized approach can be taken and encrypted user personal data 162 can be stored at a combination of server 102 and user device 104.

The encrypted personal data 162 provides a private space for a user to store their own information in association with their respective unique account user ID. This information can be stored as digital items categorized into different types of personal information items. In some examples, at least some of the personal information items have associated authentication data that indicates that the item has been authenticated through one or more methods that indicate integrity and authenticity of the digital item. For example, authentication data for a personal information item could include one or more of: a digital signature obtained through a trusted digital document signing service; a hash value assigned by a trusted process; and/or file metadata including data about an item’s creation date, its author and other details such as an indication that the item is self-attested by the user.

In example embodiments, the user information items can be tokenized items that embed the authentication data. In examples, user specific encrypted personal data 162 can be added to or updated in the future by a verified user by interacting with MUI screens presented by user device 104 for that purpose.

In example embodiments the system 100 is configured to apply predefined formatting and content requirements all personal data items that are stored in personal data 162, and this this regard then personal data 162 can be denoted as programmatic data. These formatting and content requirements can be dependent on the category type of the personal data item, and serve a purpose of building trust in the validity of the personal data items that are shared among verified users.

Examples of category types of user information items that can be stored in the user specific encrypted personal data 162 can include:
(i) Verified Profile Picture. The verified user profile picture for displaying to other users (the profile picture can, for example, be the selfie that was taken during the IDV operation of the onboarding process, or can be a further uploaded photo which has also been verified as being a photo of the user by facial matching the uploaded photo with facial biometric data of the user that was obtained during the IDV operation.).
(ii) User Payment Information. Payment information that includes payment handles through which the user can receive or make payments. In payment processing, a "payment handle" is a unique identifier that represents a specific payment method or transaction, allowing a merchant to reference that payment for future transactions or related activities. For example, a payment handle can include a secure token that encapsulates the details needed to process a payment without needing to store sensitive information. By way of example, FIG. 2C shows an example of a “My Vault” MUI screen 206 displayed by user device 104 showing examples of payment information associated with the user account holder that can be stored in the user specific personal data 162 for a user. As illustrated in FIG. 2C, MUI screen 206 can include UI controls that enable a user to input their payment handles for different third-party financial service providers such as, among other services providers: Cash App™, Interac e-Transfer™, PayPal™, Venmo™, Visa Direct™, Mastercard Direct™, and AMEX Direct™, and crypto wallet addresses. In at least some examples, user selection of a UI control to “Add Info” for a specified financial service causes the user device 104 to interface with an Application Programming Interface (API) associated with the specified financial service to obtain a verified secure token that is then stored as payment handle information as part of the user specific encrypted personal data 162. As described below, payment handles that are stored in encrypted personal data 162 can be shared in the future with another user through a secure messaging channel to ensure the payment handle is under the control of the verified user.
(iii) User Social Media Information. Social media handles for the user can be stored as personal user information items, such as the user’s public usernames for social media platforms such as Facebook™, Reddit™, WhatsApp™, Instragram™, Discord™, and the like. Application 118 can configure user device 104 to provide MUIs that enable a user to input social media handles and also interact with APIs as required to verify such handles.
(iv) User Contact Information. Unique electronic identifiers for the user can also be stored as personal user information items, including for example user first name, user full name, email addresses, phone numbers, texting numbers, and the like. Application 118 can configure user device 104 to provide MUIs that enable a user to input these electronic identifiers and also interact with APIs as required to verify such handles.
(v) Endorsement Information. As will be explained in greater detail below, verified users can earn endorsements from other verified users that they have connected with through invite codes. Endorsement items can be authenticated by the server 102 in some examples.
(vi) Other User Information. In some examples, personal information items can include other items that a user may be required to share, including for example: professional designation items that indicate a professional designation of the user and include authentication data generated by the designation granting authority (e.g., an information item that confirms the user is a lawyer, professional engineer, or registered real estate broker); education certification items that indicates, for example, a degree or diploma awarded to the user and includes authentication data generated by the granting institution; and proof of ownership of an item (e.g., when selling a pair of sneakers a picture is captured from within the application 18 of the item with metadata including date/time stamp and location. This image can be shared with a potential buyer to prove ownership and increase trust in a pending transaction).

The personal information items that are stored in user specific encrypted personal data 162 are effectively bound to the verified identify of that user. Binding, as used herein can refer to the act of tying together or connecting the verified identity of a person with a piece of information about that person, resulting in an information item that is bound to that verified identity. For example, a social media handle like @peter55342 or a crypto wallet address (40 alphanumeric characters in some cases) or an email address are pseudo-anonymous on their own. Attaching a verified identity to those pseudo-anonymous identifier items removes the anonymity and allows trust to be added. Thus, system 100 bounds the verified identity of a person to pseudo-anonymous or anonymous information about that person. In some embodiments, personal information items are cryptographically bound to a verified user identity by associating the items with keys or authentication data generated as part of the user verification process.

### Invite Code Generation

Once a user holds a verified user account they are able to obtain unique purpose-related identifiers, that are bound to their user account ID and that enable the user to connect with other users who also are verified account holders. In particular, inter-user connections are facilitated by these unique identifiers, which may, for example take the form of a unique sharable code (referred to herein as “invite codes”) that can be generated for a specified purpose (for example a transaction event).

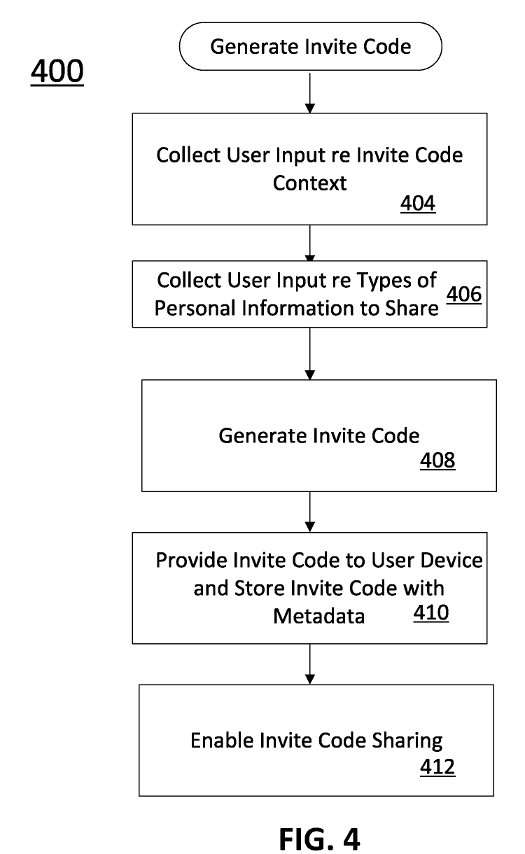

FIG. 4 shows a flow diagram illustrating an invite code generation process 400, according to example embodiments. A series of MUI screens, some of which are exemplified in FIGS. 2D to FIG. 2G, can be presented by the user device 104 throughout invite code generation process 400 to prompt the device user to provide input as required to complete the invite code generation described below.

FIG. 2D illustrates an example of MUI screen 208 that can be a home screen displayed by application 118 for a verified user. MUI screen 208 includes a UI control 210 that the user of device 104 can select to cause the invite code generation process 400 to commence. The invite code generation process 400 includes a context data collection operation 404 that requires the verified user to go through a series of MUI screens to provide data that defines context for the invite code. For example, as showing in FIG. 2E, a MUI screen 212 is displayed that includes a set of UI controls 214 that represent pre-defined user selectable options for the purpose of creating an invite code, for example “Buy and sell goods”, “Home rental”, “Community entry”, and “Ticket sale”. Depending on the selected purpose, different MUI screens can then be displayed that seek further contextual inputs from the user. For example, in the case of the purpose “Buy and sell goods”, the user can be prompted to select a user roll from a list of predefined role options (e.g., “I’m selling” or “I’m buying”) and to provide a free form description of the goods (e.g. “West Elm Harris 2-Piece Sleeper Sectional w/Storage Chaise”). Accordingly, in one example, the context data for an invite code can indicate a “purpose”, a “role” and also include a free form description. In some examples, context information can also include a user input expiry date for the invite code (for example, the user could be prompted to select from expiry options of 1 day, 3 days, 1 month, etc.)

The invite code generation process 400 can also includes a further data collection operation 404 that requires a user to specify the types of personal information items from encrypted user personal data 162 that they want to share in connection with the invite code. In example implementations, user device 104 can provide one or more MUI screens that enable the user to provide this sharable personal information type data. The personal information types can be selected from options such as “Provide profile photo”; “Provide full name”; and “Provide Social Media User Names for (select social media platform)”, for example. In some examples, the personal information type data can include a default minimum set of data types.

In example implementations, as shown in FIG. 2F, once the user device 104 has collected context data and sharable personal information type data, a summary MUI screen 216 can be presented to the user that confirms the invite context and the types of user personal information and includes a UI control 218 that can be selected by the user to cause an invite code to be generated for a planned connection by the server 102.

User selection of the UI control 218 causes the user device 104 to interact with server 102 to cause a unique invite code to be generated, as represented by operation 408. In example embodiments, user device 108 provides server 102 with an expiry date for the invite code. The unique invite code 222 can, for example, be an alphanumeric code of predefined length (4 characters in the illustrated example, although longer or shorter codes could be generated). In alternative embodiments, the invite code could be embedded in a scannable QR code, or in an electronic address link. In some embodiments, the invite code is configured as a single‑use identifier that becomes invalid for establishing additional user‑user connections following acceptance.

In an example embodiment, the database 168 at server 102 stores data about current and historic invite codes and messaging channels. In one example, the server 102 generates an invite code 222 by randomly producing a candidate code, and then confirms by referencing database 168 that the candidate code is currently available (e.g., is not associated with any previously generated invite codes that are either currently active or were active within a recent predefined time period) and, if the candidate code is available, assigns it as the unique invite code for the requesting user. The server 102 stores the unique invite code, together with associated data that indicates the user account ID of the requesting user, and a creation and/or expiry date for the invite code, in database 168.

As indicated at operation 410, the server 102 can also send the generated invite code to the user device 104, and the invite code can be stored with its associated metadata as encrypted invite data 170 in device storage 123 or at a device-linked remote storage platform. The metadata stored with an invite code can, for example, include the context data and sharable personal information item type data collected for the invite code. In some examples, some or all of invite data 170 can alternatively (or additionally) be stored in database 168 of server 102 or at another centralized location.

FIG. 2G illustrates a MUI screen 220 that can be displayed by user device 102, showing a 4-character generated invite code 222 that has been provided by server 102 in response to an invite code request. Once an invite code has been generated, it can be shared by the user. As indicated in FIG. 2G, in example embodiments the invite code 222 can be copied into a clipboard of user device 104 in response to user selection of either a “Copy with Explanation” UI control 224 or user selection of a “Copy Invite Code Only” UI control 226.

In the case of user selection of “Copy with Explanation” UI control 224, user device 104 causes the invite code “L8RS” 222 to be copied into a clipboard of user device 104 with a predefined explanation for prospective invitees - for example “In interested, connect with me by entering the invite code L8RS in the [name of application 18] app.” The contents of the clipboard, including the invite code “L8RS” can then be pasted by the user of the device 104 into a free form field of a further device app as desired, and posted or sent for other users to see. By way of example, the clipboard contents could be pasted into an add posting, or an email message, or a text.

In the case of user selection of “Copy Invite Code Only” UI control 226, user device 104 causes the invite code “L8RS” 222 to be copied into a clipboard of user device 104 on its own. The contents of the clipboard, including the invite code “L8RS” can then be pasted by the user of the device into an input field of a further device app as desired, and posted or sent for other users to see. The “Copy Invite Code Only” option may for example be useful if the target app includes a specific input field intended for an invite code.

Invite codes can be shared verbally, or more often digitally, either through email or text messaging or in a community channel on Facebook™, Reddit™, Whatsapp™, Discord™ or some other social media platform. Invite codes can also be embedded in links or QRcodes.

### Accepting an Invite Code – Unverified Second User

Once an invite code has been shared by a first user (e.g., the user associated with first user device 104A), it can be accepted by a second user (e.g., the user of second user device 104B) who is also a verified account holder.

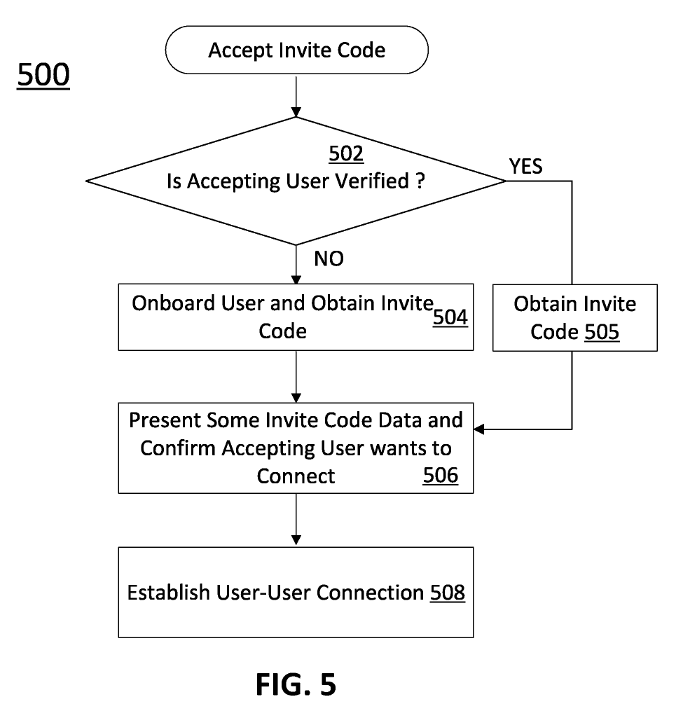

FIG. 5 shows a flow diagram illustrating an invite code acceptance process 500, according to example embodiments. In order to accept an invite, the second user can launch the application 110 on their own user device 104B. As represented by decision operation 502, if the second user is not yet registered as a verified account holder (also referred to herein as a verified user) with verified user connection system 100, the system 100 will need to onboard the second user (operation 504) by requiring the user to go through the onboarding process 300 described above. Operation 504 can also include obtaining the invite code from the second user.

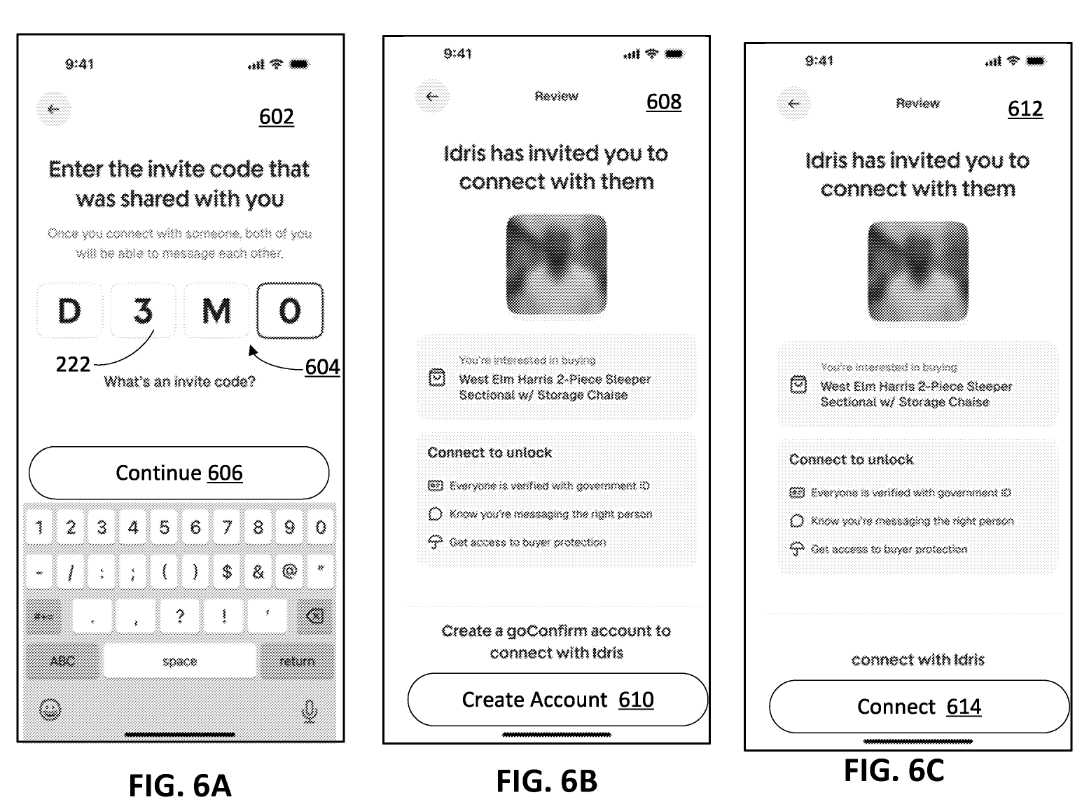

Regarding the case where the second user is not a verified user, as part of operation 504, the MUI screen 202 of FIG. 2A can be generated when a second user who is not an verified account holder (or is not logged in) launches application 118 on second user device 104B. Selection by the second user of “Accept an Invite” UI control in MUI screen 202 can cause the second user device 104B to display a further MUI screen 602, as shown in FIG. 6A, that includes an invite code input field 604 for the user to enter the invite code 222 (e.g., D3MO) that that was previously shared by the first user. A UI control “Continue” 606 is activated once an invite code is entered in invite code input field 604.

User selection of the UI control “Continue” 606 can, in an example implementation, cause the second user device 104B to cause server 102 to retrieve information associated with the input invite code from database 168, including the unique user account ID of the user account holder for whom the invite code was generated (i.e., the first user in this example). Upon linking the invite code to the first user, the server 102 can retrieve additional data related to the invite code, including some or all of the context data that is associated with the invite code as well as the pre-connection sharable user information associated with the user.

On some examples, at this point, server 102 can provide some of the invite data that is associated with the invite code 222 for display in a further MUI screen 608 (FIG. 6B) on the second user device 104B. For example, in FIG. 6B, free-form descriptive data from the invite context data “West Elm Harris 2-Piece Sleeper Sectional w/Storage Chaise” is displayed, along with the pre-connection sharable user information (e.g., first name (“Idris”), together with the blurred-beyond-recognition version of the first user’s verified profile picture). This displayed information may be compared by the second user to confirm that it overlaps information that the first user included in their posting that included the invite code, allowing the second user to gain some initial comfort that the invite code 222 is a valid code. At this point, if the second user wants to proceed further, they must select the UI control 610 to start the onboarding process 300 and go through the above provided steps.

As represented by operation 506 in FIG. 5, once the second user has gone through the onboarding process 300 and become a verified user, the second user device 104B can display a MUI screen 612 (see FIG. 6C) that is similar to the MUI screen 608 described above, but which includes a “Connect” UI control 614 that can be selected by the second user to connect with the first user.

### Accepting an Invite Code – Previously Verified Second User

In the case where the second user is already a verified account holder at the start of invite code acceptance process 500, the second user device 104B will have exchanged data with the server 102 confirming the second user’s unique user ID when the application 118 was launched on the second user device 104B, enabling the server 102 to confirm that the user is a verified user. In such case, the second user can be prompted to provide the invite code (operation 505) without requiring user onboarding. For example, when a logged in and verified user launches the application 118 on the second user device 104A, a home MUI screen will be immediately displayed, which could for example take the form of MUI screen 208 of FIG. 2D. User selection of an accept invite UI control 230 causes second user device 104B to display MUI screen 602 (FIG. 6A) that includes an invite code input field 604 for the user to enter the invite code 222 (e.g., D3MO). Input of the invite code by the verified second user will bring up the MUI screen 612 (FIG. 6C) which includes a “Connect” UI control 614 that can be selected by the second user to connect with the first user. As noted above in respect of MUI screen 608, some of the invite data and pre-connection user sharable information that is associated with the invite code 222 can be displayed in MUI screen 612 to provide the second user with comfort about the validity and accuracy of the invite code prior to proceeding to connect with the first user.

In some examples, prior to proceeding with establishing a connection, in at least some examples the second user can be presented with an intermediate MUI screen (not shown) that confirms the information that the second user is willing to share with the first user (e.g., similar to the “Info you’ll swap with others” section of MUIS screen 216 of FIG. 2F). Similar to the first user, the second user may be able to edit the types of personal information that they are willing to share.

Finally, upon receiving a final confirmation input from the second user that the second user wants to accept an invite code, the system 100 causes a user-user connection to be established (operation 508) between the first user and second user. The user-user connection is tied to the invite code; two users can have multiple connections in system 100, with each connection being associated with a different invite code (as noted above, invite codes each have an associated purpose, thus two users can have multiple connections with each other that each relate to a different purpose.)

Additionally, multiple different users can also accept an invite code, such that multiple users-user connections between the first user (the invite code creator) and respective second users can be established and co-exist.

As part of operation 508, server 102 can update the administrative user account data 174 that is stored in respect of the invite code to include a timestamped indication that it has been accepted and to indicate the unique user account ID of the accepting verified user and acceptance date and time, among other things. Similarly, invite data 170 stored at user devices 104A and 104B can be updated to respectively indicated the status of created and accepted invite codes associated with the verified users of the device 104A, 104B, acceptance dates, and user account ID’s of the parties involved.

### User-User Connection

As noted above, the establishment of connection between two verified users enables an exchange of identity-bound information to occur. Once two identity-verified users have connected through an invite code, they have the ability, either programmatically or through ad-hoc chat, to exchange information that is now bound to their identities. The selection of what data to share is controlled by the user, ensuring the privacy preserving focus of the platform.

In this regard, the establishment of a user-user connection effectively causes the server 102 to establish a secure encrypted messaging channel 166 between the first user device 104A and the second user device 194B. The information that is exchanged through the channel 166 is protected by end-to-end encryption, which can be achieved using known secure messaging channel techniques. Data that is required to support the messaging channel 166 (including required encryption and decryption keys can be stored, as required, as part of connection data 172 at the respective user devices 104 and as part of the administrative user account data 174 stored by server database 174.

The information that is exchanged between the first user device 104A and the second user device 194B can include at least two categories of data:
(i) Programmatic information – this includes information from the respective user personal data 162 collections (also referred to as user vaults) that correspond to the types of data that the user has indicated they are prepared to share. As noted above, the format and content of programmatic information is predefined. The first user device 104A and the second user device 194B are configured to share and present this information in defined formats. The programmatic information can, for example, be considered a “shared vault” in that it provides as mechanism by which selected items from each user’s personal data 162 can be shared, through a secure messaging channel 166, in a defined format and with associated authentication data.
(ii) Free format information – this includes information that users can input as message content and exchange in a manner typical of direct messaging.

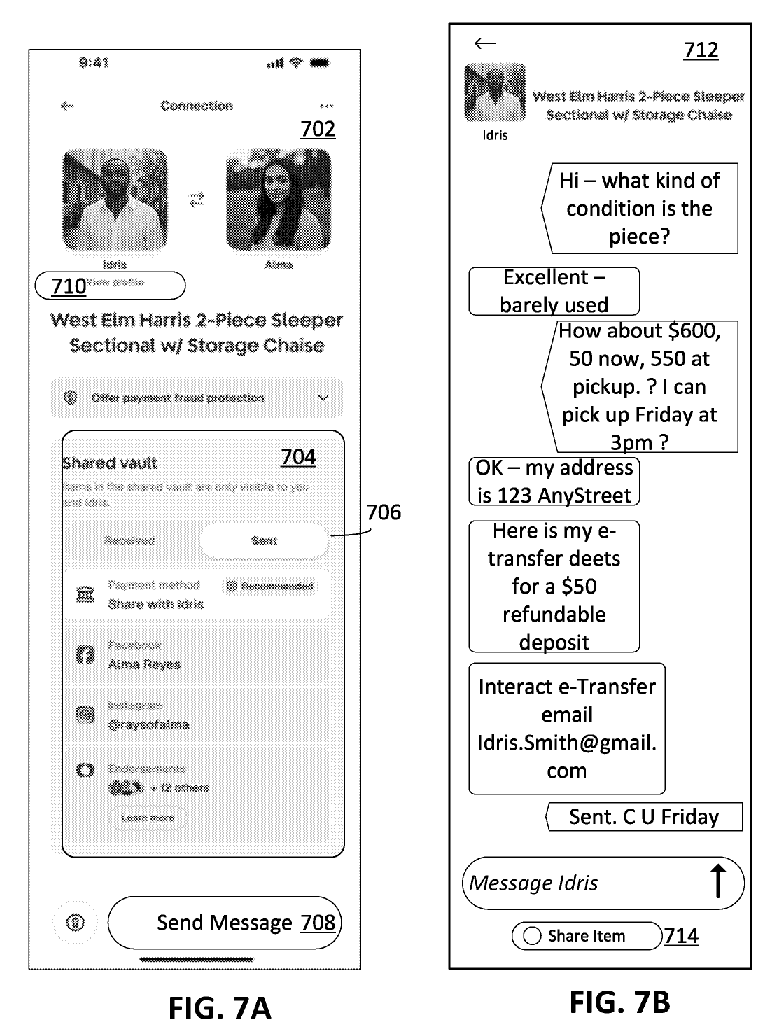

In this regard, the user devices 104A, 104B can be configured by application 118 to generate MUI displays that support the presentation of shared Programmatic information and the exchange of free format information. By way of example, FIG. 7B illustrates an example of a “Connection” MUI screen 702 displayed by second user device 104B in the case where two users, “Idris” and “Alma” have become connected through the process of Alma accepting, using the second user device 104B, an Invite Code shared by Idris. MUI 702 provides a trusted source of information, based on which Alma can decide to proceed with communicating with Idris with the intention of achieving the purpose that is associated with the invite code that the connection corresponds to.

Among other things, MUI screen 702 includes: (i) Idris’ first name and his verified profile picture, in an unblurred state (the unblurred picture is an example of Programmatic personal user data item, obtained from Idris’ personal data 162). This information can help Alma conform Idris’ identity if a personal or virtual meeting is planned. Additionally, Alma can compare the photo and first name to images and the name that Idris has been using on other platforms, for example the platform where he provided the Invite Code. (ii) Context data associated with the Invite Code that resulted in the connection (e.g. the free from description “West Elm Harris 2-Piece Sleeper Sectional w/Storage Chaise”); (iii) A programmatic “shared vault” UI section 704, that includes formatted display items that each present a respective personal data element obtained from the respective user personal data 162 that the first and second users have previously indicted as sharable. In the illustrated example, a sliding UI control 706 allows the second user device to alternate between showing second user Alma’s personal data elements and first user Idris’ personal data elements as respective display items in the shared vault UI section 704. In the illustrated example, these personal data elements, which as noted above can each have associated authentication data, include “Payment Method”; social media user-names; and User Endorsement Data (Alma has 15 endorsements in the illustrated example). The personal data elements required to populate the respective items of shared vault UI section 704 can be shared automatically between the user devices 104A, 104B using the encrypted messaging channel 166 without requiring any user input. In at least some examples, one or more of the items included in shared vault UI section 704 can be selected to link to a further display that presents addition information, or in some cases modify (where authorized) the user’s own personal data items.

In the illustrated example, MUI screen 702 includes a “view profile” UI control 710 that can enable one verified user to view profile information about the other user. In some examples, the profile information for a user can include additional personal data items from the user’s personal data 162 that the user has agreed to share with connections made via the current Invite Code.

MUI screen 702 further includes a “Send Message” UI control 708 that can be selected by the device user to participate in free-form ad-hoc messaging using the encrypted messaging channel 166. FIG. 7B illustrates a further MUI screen 712 that can be displayed by a user device (e.g., device 104B) in response to section of the “Send Message” UI control 708 in MUI screen 702. Information, either free-form or vault items, can be exchanged. In the illustrated example, the second user receives a payment handle from within the identity-verified messaging channel. The receiving user can be assured with high confidence that the information they are receiving is bound to the identity attached to the connection

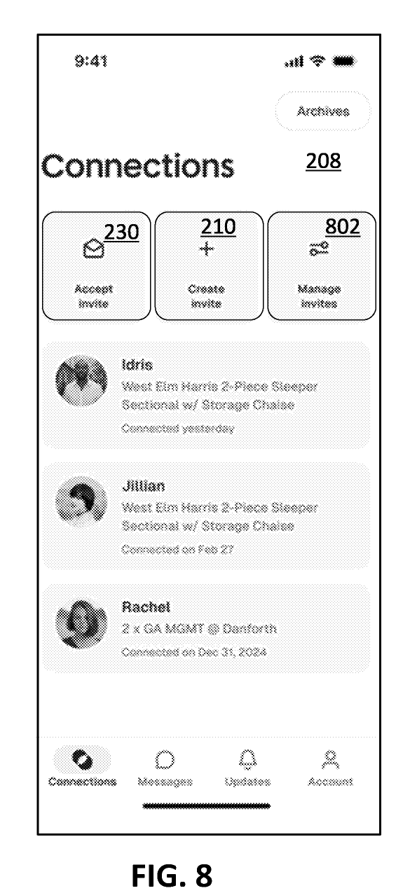

In example implementation, a verified user can view information about the active connections and invite codes that they have. For example, FIG. 8 shows an updated version of “home” MUI screen 208 that enable the user of user device to view a set of user selectable display elements that each represent information about a respective connection. For example, each display item can include the connecting user’s verified profile picture, first name, and identifying information about the invite code that the connection corresponds to. As represented in FIG. 8, UI control 802 can be provided to enable users to view further MUI screens that include information about invite codes that they have caused to be generated.

In example implementations, as described above, invite codes can have a user defined expiry date after which no new connections can be made using that invite code. In some examples, connections associated with a expired invite code may be automatically archived after a defined duration of time passes.

### Endorsements

As noted above, in example embodiments, verified users can receive endorsements from and provide endorsements for other verified users that they have connected with. For example, an endorsement can be earned when defined criteria are achieved, and can last for a defined duration (e.g., 1 year). In one example the defined criteria can be as follows: Endorsements are earned when two verified users who become connected via an invite code both agree that the connection was successful. A verified user can only earn one endorsement per a defined period (e.g. one year) per other verified user (i.e., a verified user can’t earn multiple endorsements based on multiple connections with the same person, each endorsement must correspond to a unique verified user).

As noted above, endorsement data can be stored as part of user personal data 162 that can then be displayed in information shred with other users (see for example “Endorsements” personal data element of shared vault UI section 704 in FIG. 7A). Each endorsement can have data associated with it that indicates information (e.g., information such as that used as pre-connection sharable user data) about the verified user that agrees to the endorsement and information about the invite code context associated with the connection that resulted in the endorsement. The endorsements can be perceived as valuable indicators of character and integrity as they can only be obtained when two verified users have actually connected and consent to the endorsements, which mitigates against the challenges of fake endorsements that are prevalent on social media platforms. Because the endorsements are not embedded in a specific on-line marketplace (e.g. Facebook, etc), they are portable and the reputation created can be used across all platforms and places where trust needs to be created. In one example implementation, server 102 can be configured to prompt verified users by emails or in-app notifications users cause users to be confirm if a connection has concluded successfully and agree to provide an endorsement.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The terms “substantially” and “approximately” as used in this disclosure can mean that the recited characteristic, parameter, or value need not be achieved exactly, but that deviations or variations including for example, tolerances, measurement error measurement accuracy limitations and other factors known to those skilled in the art, may occur in amounts that do not preclude the effect the characteristic was intended to provide. By way of illustration, in some examples, the terms “substantially” and “approximately”, can mean a range of within 5% of the stated characteristic.

As used herein, statements that a second item is “based on” a first item can mean that properties of the second item are affected or determined at least in part by properties of the first item. The first item can be considered an input to an operation or calculation, or a series of operations or calculations that produces the second item as an output that is not independent from the first item.

1. A computer-implemented method for enabling exchange of identity-bound information between previously unconnected users, the method comprising:
receiving, by a server from a first user device associated with a first user, a request to generate an invite code for the first user, the first user having previously completed a verification process;
generating, by the server, the invite code for the first user;
storing, by the server, the invite code in association with a distinct user identifier of the first user;
receiving, by the server from a second user device associated with a second user, the invite code;
identifying, by the server, the distinct user identifier of the first user based on the invite code;
determining, by the server, whether the second user has completed the verification process;
responsive to determining that the second user has completed the verification process, causing the second user device to present a selectable option to connect the second user with the first user; and
responsive to receiving an indication that the selectable option has been selected, causing a secure messaging channel to be established between the first user device and the second user device.

2. The computer-implemented method of claim 1, wherein the verification process for each of the first user and the second user comprises:
performing automated identity verification based on biometric data obtained from the user and a representation of a government-issued identification document provided by the user;
performing duplicate-user checking by comparing the biometric data obtained from the user against stored biometric data for users who have previously undergone the verification process; and
responsive to successful automated identity verification and successful duplicate-user checking, updating user data associated with the distinct user identifier of the user to indicate that the user is a verified user.

3. The computer-implemented method of claim 1, wherein generating the invite code further comprises obtaining one or more context data items from the first user via the first user device, and wherein causing the second user device to present the selectable option comprises causing the second user device to present at least one of the one or more context data items with the selectable option.

4. The computer-implemented method of claim 3, wherein the one or more context data items comprise a selected purpose, a selected role, and a text description.

5. The computer-implemented method of claim 1, further comprising:
storing, for each of the first user and the second user, respective personal information items including one or more authenticated personal information items that are bound to a verified identity of the respective user; and
transmitting, via the secure messaging channel, at least one authenticated personal information item of the first user to the second user device and at least one authenticated personal information item of the second user to the first user device.

6. The computer-implemented method of claim 5, wherein at least one authenticated personal information item comprises a payment handle.

7. The computer-implemented method of claim 5, wherein the at least one authenticated personal information item comprises a verified profile picture of at least one of the first user or the second user.

8. The computer-implemented method of claim 5, wherein the at least one authenticated personal information item comprises a social media identifier of at least one of the first user or the second user.

9. The computer-implemented method of claim 5, wherein the at least one authenticated personal information item comprises endorsement data associated with at least one of the first user or the second user.

10. The computer-implemented method of claim 5, further comprising causing the at least one authenticated personal information item transmitted via the secure messaging channel to be presented in a defined format at the first user device or the second user device.

11. The computer-implemented method of claim 1, wherein the secure messaging channel enables the first user and the second user to exchange free-format messages.

12. The computer-implemented method of claim 1, wherein the invite code is associated with an expiration condition and is invalidated after a successful acceptance by the second user.

13. A system for enabling exchange of identity-bound information between previously unconnected users, the system comprising:
one or more processors; and
one or more memories storing machine-executable instructions that, when executed by the one or more processors, cause the system to:
receive, from a first user device associated with a first user, a request to generate an invite code for the first user, the first user having previously completed a verification process;
generate the invite code for the first user;
store the invite code in association with a distinct user identifier of the first user;
receive, from a second user device associated with a second user, the invite code;
identify the distinct user identifier of the first user based on the invite code;
determine whether the second user has completed the verification process;
responsive to determining that the second user has completed the verification process, cause the second user device to present a selectable option to connect the second user with the first user; and
responsive to receiving an indication that the selectable option has been selected, cause a secure messaging channel to be established between the first user device and the second user device.

14. The system of claim 13, wherein the verification process for each of the first user and the second user comprises biometric verification using biometric data obtained from the user, verification of a government-issued identification document provided by the user, and duplicate-user checking based on comparison of the biometric data with stored biometric data for previously verified users.

15. The system of claim 13, wherein generation of the invite code further comprises obtaining one or more context data items from the first user via the first user device, and wherein the instructions further cause the system to present at least one of the one or more context data items with the selectable option.

16. The system of claim 15, wherein the one or more context data items comprise a selected purpose, a selected role, a text description, and an expiration condition.

17. The system of claim 13, wherein the instructions further cause the system to store, for each of the first user and the second user, respective personal information items including one or more authenticated personal information items that are bound to a verified identity of the respective user, and to transmit, via the secure messaging channel, selected authenticated personal information items between the first user device and the second user device.

18. A non-transitory processor-readable medium storing machine-executable instructions that, when executed by one or more processors, cause the one or more processors to perform the computer-implemented method of claim 1.

19. A computer‑implemented method for securely enabling exchange of identity‑bound information between previously unconnected users, the method comprising:
verifying, by one or more processors of a server, an identity of a first user by performing biometric verification using biometric data captured by a first user device and by confirming the first user is not a duplicate user based on comparison of the biometric data against stored biometric data for previously verified users;
storing, by the server, a verified user record associated with a unique user account identifier for the first user;
generating, by the server, a single‑use invite code bound to the unique user account identifier of the first user, the invite code being associated with stored context data and an expiration condition;
receiving, by the server and from a second user device, the invite code;
validating, by the server, that the invite code is unexpired and bound to the verified user record of the first user;
determining, by the server, that a second user associated with the second user device is a verified non‑duplicate user based on biometric verification;
responsive to validating the invite code and determining that the second user is verified, establishing, by the server, a secure encrypted messaging channel between the first user device and the second user device using cryptographic keys associated with the verified user records; and transmitting, via the secure encrypted messaging channel, one or more authenticated personal information items that are cryptographically bound to the verified identity of at least one of the first user or the second user.

20. A system, comprising:
one or more processors, and one or more memories storing machine-executable instructions thereon which, when executed by the one or more processors, cause the system to perform the method of claim 19.
